(19) United States
(12) Patent Application Publication
(10) Pub. No.: US 2011/0187933 A1
(43) Pub. Date: Aug. 4, 2011

(54) IMAGE DISPLAY APPARATUS AND METHOD FOR CONTROLLING IMAGE DISPLAY APPARATUS

(75) Inventors: Daisuke Kawase, Ichikawa-shi (JP); Makiko Mori, Atsugi-shi (JP); Osamu Sagano, Inagi-shi (JP)

(73) Assignee: CANON KABUSHIKI KAISHA, Tokyo (JP)

(21) Appl. No.: 13/013,400

(22) Filed: Jan. 25, 2011

(30) Foreign Application Priority Data
Feb. 3, 2010 (JP) 2010-021938

(51) Int. Cl. H04N 5/21

(52) U.S. Cl. 348/607; 348/E05.077

(57) ABSTRACT

An image display apparatus of the present invention includes: a display panel; a signal processing unit which corrects an input video signal using correction parameters, and outputs the corrected video signal to the display panel; a power supply unit which supplies voltage to the display panel; a storage unit which stores the correction parameters; and a control unit, which, at startup of the image display apparatus, executes boosting processing for boosting voltage supplied from the power supply unit to the display panel up to a voltage required for driving the display panel in stages, and transfer processing for transferring the correction parameters from the storage unit to the signal processing unit, wherein the transfer processing is processing for intermittently transferring the correction parameters using a period when boosting is not performed in the boosting processing.

### BACKGROUND OF THE INVENTION

1. Field of the Invention

The present invention relates to an image display apparatus and a method for controlling the image display apparatus.

2. Description of the Related Art

A prior art related to an image display apparatus is disclosed in, for example, Japanese Patent Application Laid-Open No. 2008-145494 and Patent Publication No. 3679712. In concrete terms, Japanese Patent Application Laid-Open No. 2008-145494 discloses a technology to reduce the uneven brightness of the display image, using a plurality of correction values (uneven brightness correction data) corresponding to identical display elements. Patent Publication No. 3679712 discloses a method for controlling the voltage for electron acceleration which is supplied to the display panel having electron-emitting devices.

Some image display apparatuses sequentially execute correction parameter transfer processing and boosting processing in order to boost the voltage to be supplied to the display panel up to a target value (voltage required for driving the display panel), and start displaying images after the completion of the correction parameter transfer processing and the boosting processing.

Recently, the data volume of correction parameters is increasing as image display apparatuses offer high definition.

In some cases, it is difficult to boost the voltage supplied to the display panel to the target value all at once. For example, if the voltage is boosted to the target value all at once in a field emission display (FED), which accelerates electrons emitted from an electron source and generates emission of light by having the accelerated electrons collide with phosphor, an unexpected discharge may be generated or dust may be adsorbed by the surface of the display panel. To solve this problem, voltage to be supplied to the display panel may be boosted in stages to the target value.

As a result, the processing time of transfer processing and the processing time of boosting processing increases, and it takes a long time (several seconds) until both processings complete. In other words, it takes a long time until the display of images starts. On the other hand, for users, it is desirable that the time until the start of the display of images is short.

### SUMMARY OF THE INVENTION

The present invention, provides a technology which allows completing the boosting processing for boosting voltage supplied to the display panel and the transfer processing to transfer the correction parameters, in a short time.

The image display apparatus of the present invention has: a display panel; a signal processing unit which corrects an input video signal using correction parameters, and outputs the corrected video signal to the display panel; a power supply unit which supplies voltage to the display panel; a storage unit which stores the correction parameters; and a control unit, which, at startup of the image display apparatus, executes boosting processing for boosting voltage supplied from the power supply unit to the display panel up to a voltage required for driving the display panel in stages, and transfer processing for transferring the correction parameters from the storage unit to the signal processing unit, wherein the transfer processing is processing for intermittently transferring the correction parameters using a period when boosting is not performed in the boosting processing.

According to the present invention, the boosting processing for boosting voltage supplied to the display panel and the transfer processing to transfer the correction parameters can be completed in a short time.

Further features of the present invention will become apparent from the following description of exemplary embodiments with reference to the attached drawings.

### BRIEF DESCRIPTION OF THE DRAWINGS

FIG. 1 is a diagram depicting an example of a functional configuration of an image display apparatus according to the present example;

FIG. 2 is a diagram depicting an example of a configuration of a display panel according to the present example;

FIG. 3A is a graph depicting an example of the time-based change of the voltage indication value;

FIG. 3B is a graph enlarging a part of FIG. 3A;

FIG. 4 is a diagram depicting an example of a method for executing the boosting processing and the transfer processing;

FIG. 5A is a graph depicting an example of a time-based change of the voltage indication value;

FIG. 5B is a graph enlarging a part of FIG. 5A;

FIG. 5C is a diagram depicting an example of a method for executing the boosting processing and the transfer processing;

FIG. 5D is a diagram depicting an example of a method for executing the boosting processing and the transfer processing;

FIG. 6A is a flow chart depicting an example of the processing flow of the image display apparatus according to Example 3, until the video image is displayed; and

FIG. 6B is a diagram depicting an example of a method for executing the boosting processing and the transfer processing.

### DESCRIPTION OF THE EMBODIMENTS

Examples of an image display apparatus according to the present embodiment and a control method thereof will now be described.

### Example 1

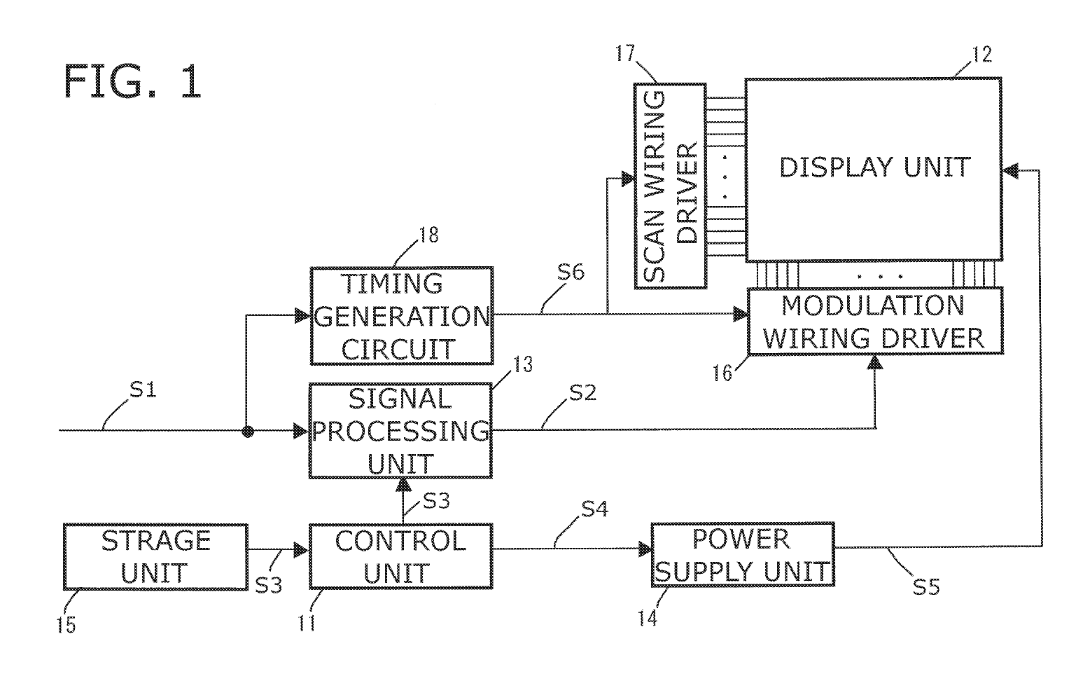

FIG. 1 is a block diagram depicting a functional configuration of an image display apparatus according to this example. The image display apparatus according to this example displays an image on a display panel 12 (display unit) based on an input video signal S1 (video signal which has been input) including a vertical synchronization signal and a horizontal synchronization signal. In this example, the display panel 12 has a plurality of scan wirings (row wirings), a plurality of modulation wirings (column wirings), and a plurality of display elements disposed on intersections of a plurality of scan wirings and a plurality of modulating wirings. The column wiring may be scan wiring, and the row wiring may be modulation wiring.

A timing generation circuit 18 generates a drive timing signal S6 based on the vertical synchronization signal and the horizontal synchronization signal which have been input.

A signal processing unit 13 converts (corrects) the input video signal S1 to drive data S2 suitable for display on the display panel 12 using a correction parameter S3, and outputs the drive data to the display panel 12 via a modulation wiring driver 16.

The modulation wiring driver 16 and a scan wiring driver 17 select a scan wiring and a modulation wiring using the drive timing signal 86 and the drive data S2. As a result, a display element existing at the intersection of the selected scan wiring and modulation wiring is driven, emits light, by which an image is displayed.

A power supply unit 14 supplies (applies) voltage (supply voltage S5) to the display panel 12. In concrete terms, the supply voltage 85 according to the later mentioned voltage indication value S4 is supplied to the display panel 12.

A storage unit 15 stores the correction parameter S3. For the storage unit 5, a non-volatile memory, magnetic disk, optical disk or the like, can be used. The correction parameter S3 is a parameter for correcting the input video signal S1. The correction parameter S3 is constituted by a plurality of data (e.g. uneven brightness correction data for correcting uneven brightness).

A control unit 11 executes the boosting processing and the transfer processing when the image display apparatus is started up. The control unit 11 is constituted by a microcomputer, for example.

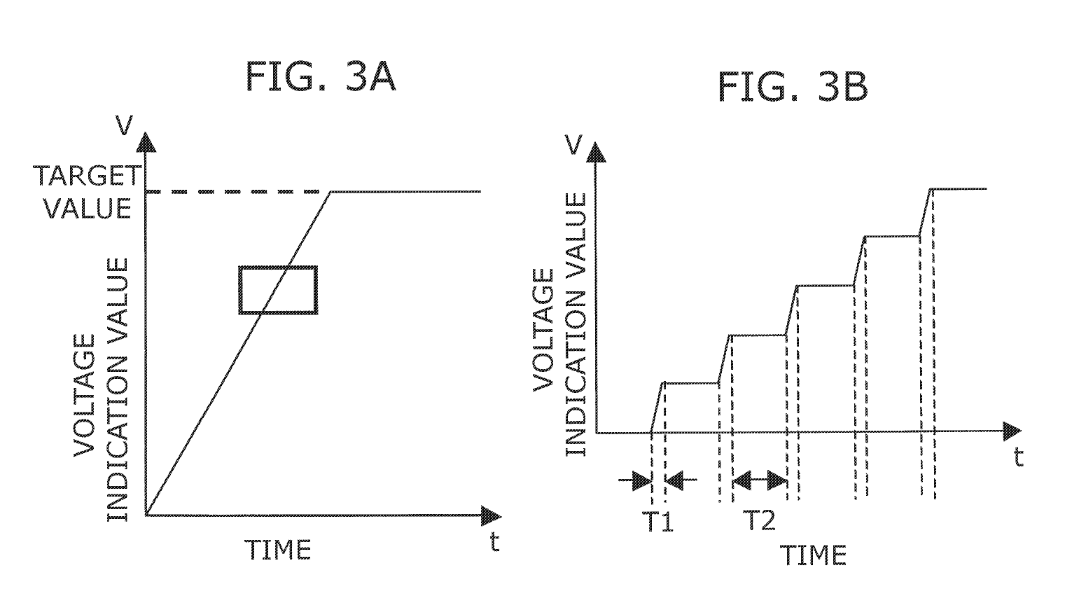

The boosting processing is a processing for boosting the supply voltage S5, in stages, up to the voltage (target value) required for driving the display panel. In concrete terms, the control unit 11 outputs the voltage indication value S4 to indicate a value of the supply voltage S5 to the power supply unit 14. FIG. 3A shows an example of a time-based change of the voltage indication value S4, and FIG. 3B shows a graph enlarging a part of FIG. 3A (bold frame portion). In this example, as FIG. 3B shows, the control unit 11 sets an appropriate standby time (period until the voltage indication value S4 is output next; period T2 in which boosting is not performed) after the voltage indication value S4 is output (after period T1). Thereby the supply voltage S3 is boosted in stages. By boosting the supply voltage S3 in stages, the generation of an unexpected discharge (results in a breakdown of circuits) and the absorption of dust to the surface of the display panel, can be suppressed.

The transfer processing is a processing for transferring the correction parameter S3 from the storage unit 15 to the signal processing unit 13.

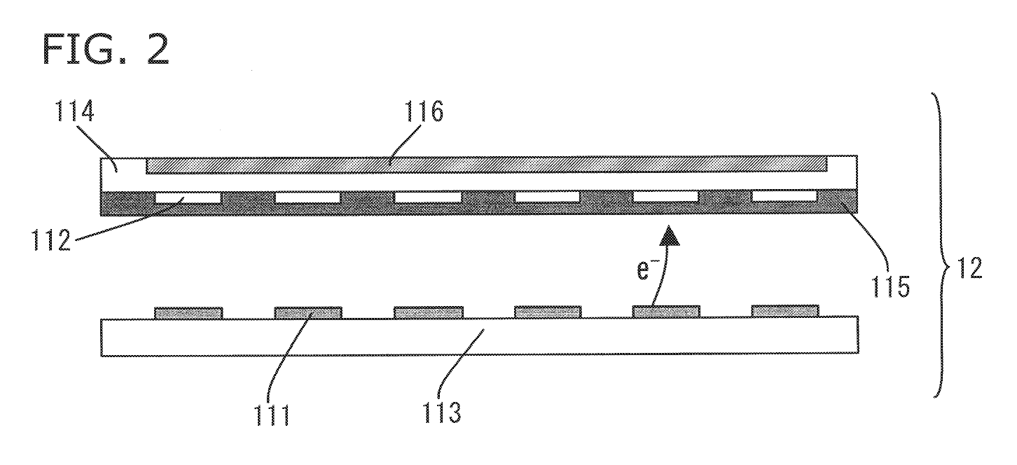

In this example, an example of using a field emission display (FED) as the display panel 12, that is using an electron-emitting device (particularly a surface-conduction electron-emitting device) as the display element will be described. FIG. 2 shows a cross-sectional view of the display panel 12. The display panel 12 has a rear plate (RP) 113 and a face plate (FP) 114. The RP 113 has a plurality of scan wirings, a plurality of modulation wirings, and a plurality of electron-emitting devices 111. The FP 114 has a plurality of phosphors 112 disposed facing the plurality of electron-emitting devices, and an anode electrode 115 which is disposed at the electron-emitting device side of the phosphors 112. In the FED, the supply voltage 35 is supplied to the display panel 12 (anode electrode 115) so that the potential at the face plate side becomes higher than the rear plate side. Thereby electrons emitted from the electron-emitting device 111 accelerate and collide with the phosphors 112. By the electrons colliding with the phosphors 112, the phosphors 112 emit light, and an image is displayed on the image display area 116. The display panel 12 is not limited to FED, but may be a liquid crystal display, plasma display, organic EL display or the like.

In the image display apparatus according to this example, the display of an image is started after the transfer processing and boosting processing are completed. In this example, it is regarded that the image is displayed when the correction parameter S3 is transferred and the image is displayed in a state of supply voltage S5 reaching the target value. In other words, if the image is displayed in a state of transfer processing and boosting processing being insufficient (state where correction processing, using the correction parameter S3, and boosting of the supply voltage are incomplete), it is not regarded that the image is displayed. Until the transfer processing and boosting processing are completed, a black image may be displayed, or an image in a state where transfer processing and boosting processing are incomplete may be displayed.

Transfer processing and boosting processing will now be described in detail.

Conventionally transfer processing and boosting processing are sequentially executed (that is, after one of transfer processing and boosting processing is completed, the other processing is started). As a result, it takes a long time (about several seconds) from startup of the image display apparatus to the start of display of the image. Time until the start of display of the image should be short, but it is difficult to decrease the respective processing time of the transfer processing and boosting processing. For example, decreasing the boosting processing time is limited, since an unexpected discharge or an adsorption of dust on the surface of the display panel may occur.

Therefore in this example, the time until both processings are completed is decreased, by intermittently transferring correction parameters utilizing a period in which boosting is not performed in the boosting processing. This will be described in detail.

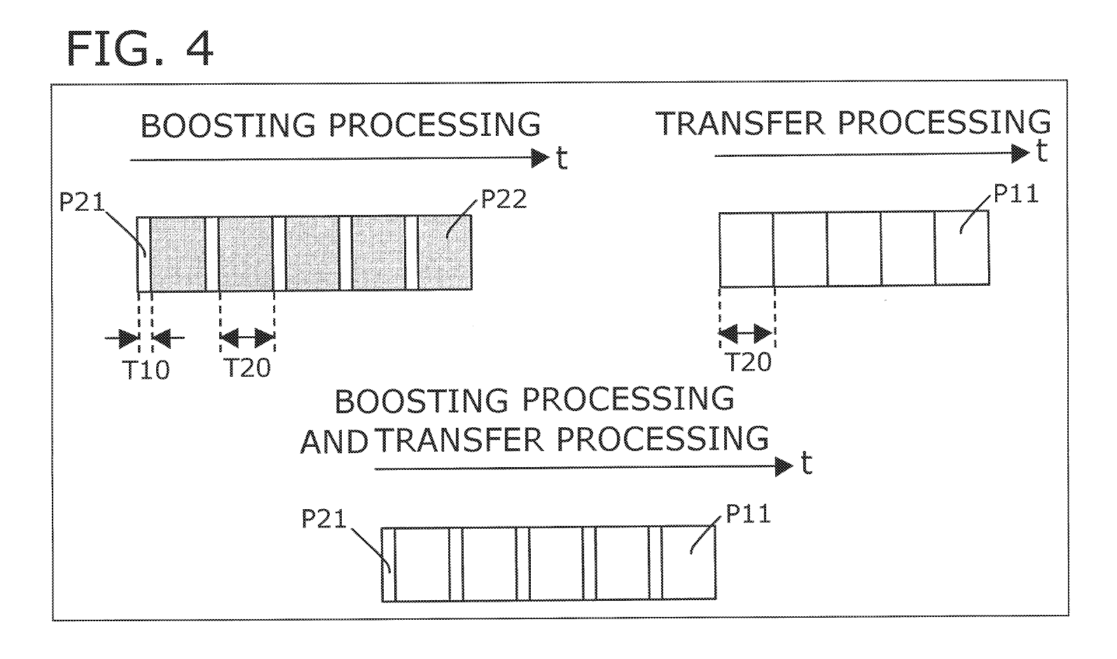

As FIG. 4 shows, in boosting processing, the voltage indication value output processing P21 of which processing time is T10 and standby processing P22 of which processing time is T20 are alternately repeated. The voltage indication value output processing P21 is a processing for outputting the voltage indication value to the power supply unit 14, and the standby processing P22 is a processing for not outputting anything to the power supply unit 14. In this example, as FIG. 4 shows, the control unit 11 divides transfer processing into a plurality of sub-transfer processings P11 of which respective processing time is the same as the processing time T20 of the standby processing P22, and executes the respective sub-transfer processing P11 during standby processing P22. In concrete terms, the control unit 11 executes the voltage indication value output processing P21 and the sub-transfer processing L11 alternately. In FIG. 4, the voltage indication value output processing P21 is executed first, but the sub-transfer processing P11 may be executed first.

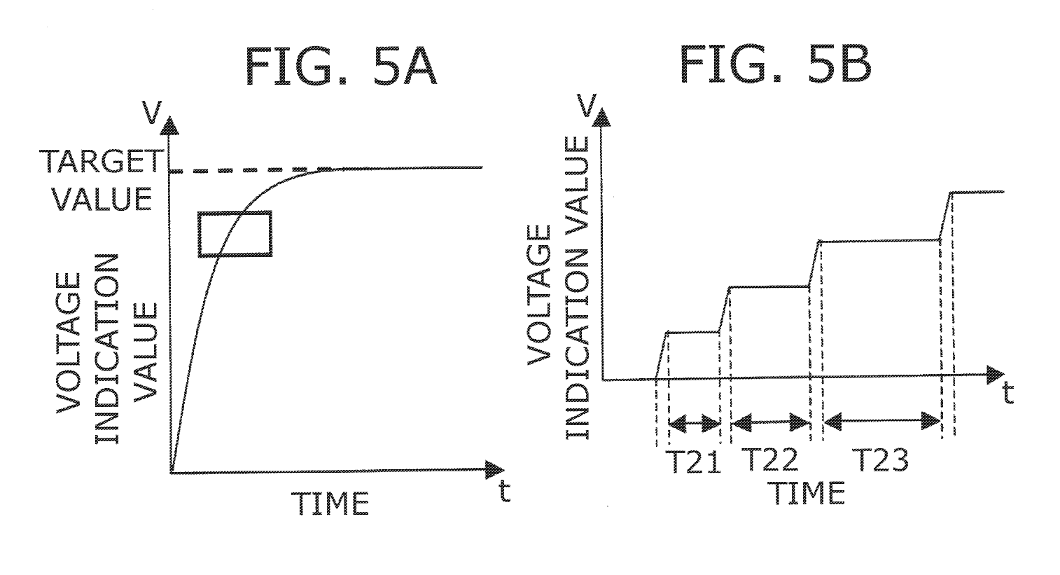

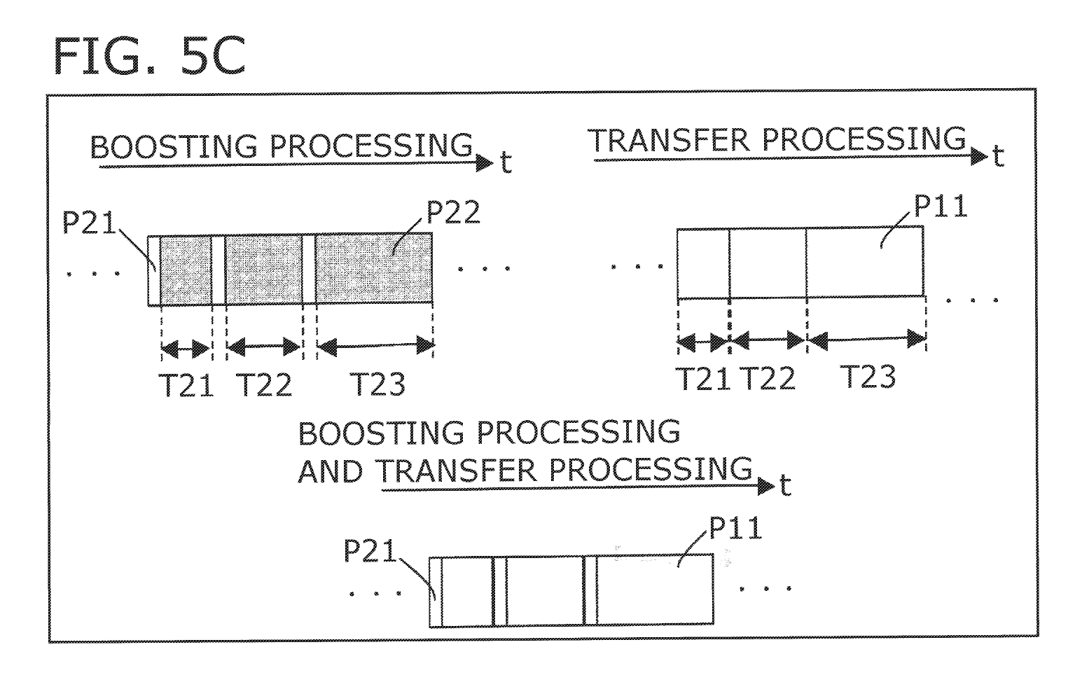

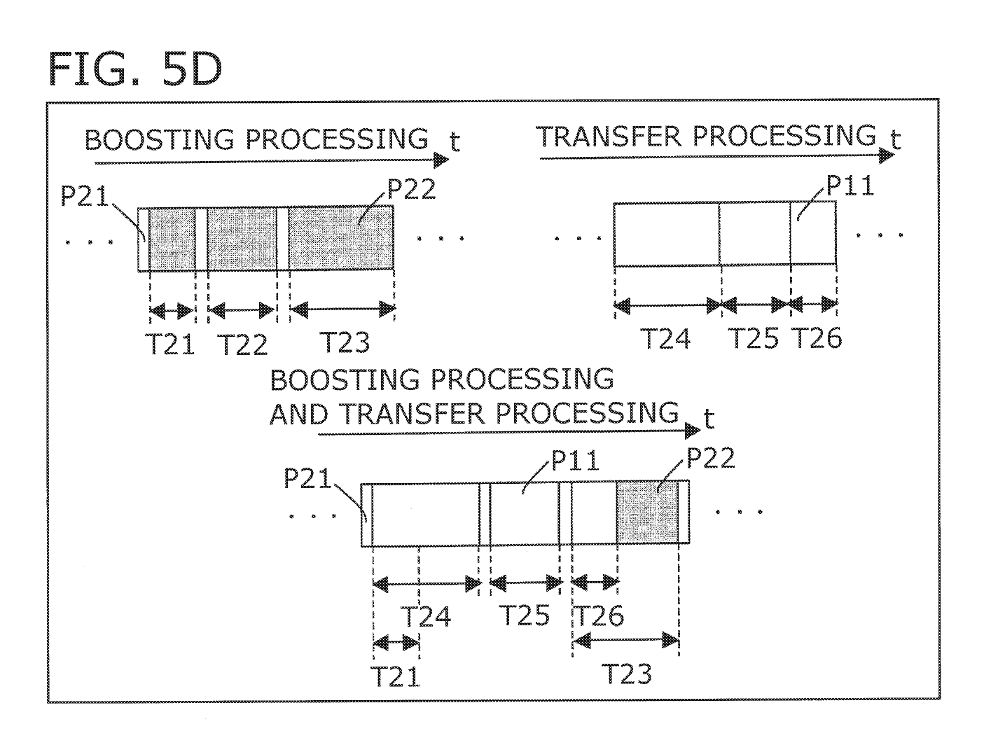

FIG. 4 shows the case when the processing time of the standby processing P22 is constant, but as FIG. 5A to FIG. 5D show, the processing time of the standby processing P22 may not be constant. FIG. 5A shows an example of a time-based change of the voltage indication value upon boosting the supply voltage nonlinearly, and FIG. 5B shows a graph enlarging a part of FIG. 5A (bold frame portion). If the volt age value to be boosted in the voltage indication value output processing P21 is constant, the processing time of the standby processing P22 does not become constant.

In such a case as well, the transfer processing is divided into a plurality of sub-transfer processings P11 so that each processing time is the same as the processing time of the standby processing P22. For example, as FIG. 5C shows, the transfer processing is divided into three sub-transfer processing P11, so that each processing time is the same as the processing times T21, T22 and T23 of the standby processing P22 respectively. Then the voltage indication value output processing P21 and the sub-transfer processing P11 are executed alternately.

The processing time of the sub-transfer processing P11 need not always match the processing time of the standby processing P22 (depending on the structure of data constituting the correction parameter, a perfect match may not be possible). For example, as FIG. 5D shows, the transfer processing may be divided into sub-transfer processings (three sub-transfer processings P11, of which the respective processing times are T24, T25 and T26), which are not related to the processing times T21, T22 and T23 of the standby processing P22. If the processing time of the sub-transfer processing P11 is longer than the processing time of the standby processing P22, the processing time of the standby processing P22 is reset to the processing time of the transfer processing P11 or longer (resetting the processing time of standby processing). In the case of FIG. 5D, the processing time T24 of the sub-transfer processing is longer than the processing time T21 of the standby processing, so the processing time T21 of the standby processing is reset to a time the same as the processing time T24 of the sub-transfer processing. The processing time T22 of the standby processing and the processing time T25 of the sub-transfer processing are the same, and the processing time 26 of the sub-transfer processing is shorter than the processing time T23 of the standby processing, so the processing times T22 and T23 of the standby processing are not changed.

If the processing time of the sub-transfer processing P11 is longer than the processing time of the standby processing P22, the next voltage indication value output processing P21 is executed after the sub-transfer processing P11 is completed. If the processing time of the sub-transfer processing P11 is shorter than the processing time of the standby processing P22, the next voltage indication value output processing P21 is not executed after the sub-transfer processing P11 is completed, until the processing time of the standby processing P22 elapses.

By resetting the processing time of the standby processing like this, transfer processing can be executed using the processing time of the standby processing effectively, even if the processing time of the sub-transfer processing and processing time of the standby processing are different.

The length of the processing time of the standby processing may be reset by the control unit while executing the boosting processing and transfer processing, or may be set in advance according to the processing time of the sub-transfer processing. The length of the processing time of the standby processing may be set at any timing only if it is set to the time required for transferring data to be transferred during this period or longer.

As described above, according to this example, the boosting processing and transfer processing can be completed in a short time by intermittently transferring the correction parameters utilizing the period in which boosting is not performed in the boosting processing. As a result, time from the startup of the image display apparatus to the display of the image can be decreased.

In this example, a case when the supply voltage is a voltage that is supplied to the display panel for accelerating electrons emitted from the electron-emitting devices was described, but the supply voltage is not limited to this. The present invention can be applied only if the display voltage is a voltage required for displaying images on the display panel.

### Example 2

In this example, a case when one of boosting processing and transfer processing is completed first in the configuration of Example 1 will be described. Description on functions and configuration the same as Example 1 is omitted.

In this example, after one of boosting processing and transfer processing is completed first, the control unit 11 executes the other processing continuously, and completes this processing.

In concrete terms, in the case of the boosting processing to be completed first, the sub-transfer processing P11 and the voltage indication value output processing P21 are executed alternately, then the remaining correction parameters are transferred continuously. In the case of the transfer processing to be completed first, the sub-transfer processing P11 and the voltage indication value output processing P21 are executed alternately, then the voltage indication value output processing P21 and the standby processing P22 are executed alternately.

As described above, according to this example, the total processing time of the transfer processing and the boosting processing can be decreased, just like Example 1. Even in the case of one of boosting processing and transfer processing to be completed first, the other processing can also be completed.

### Example 3

In this example, a case of the correction parameter being constituted by a plurality of uneven brightness correction data will be described. Since uneven brightness correction data is required for each display element, p×q×N (both p and q are natural numbers and N is a number of data required for each display element) are required for a display panel in which p rows×q columns of display elements are disposed.

N number of data and a method for correction using this data will be described first.

Dispersion of brightness depends on the gradation value. Therefore it is preferable that the uneven brightness correction data is provided for a number of gradations of brightness for each display element (it is preferable that data corresponding to each gradation value is provided). However if the uneven brightness correction data is provided for a number of gradations, the data volume becomes enormous. Therefore in this example, only the uneven brightness correction data (N number of data) corresponding to a part of the gradation value is provided. The signal processing unit 13 calculates the uneven brightness correction data corresponding to the other gradation values (unprovided uneven brightness correction data) by interpolating or extrapolating the N number of uneven brightness correction data. Then this pixel value is corrected using the uneven brightness correction data corresponding to the input pixel value (gradation value).

The unprovided uneven brightness correction data can be more accurately calculated as the number of uneven brightness correction data to be used is high, but can be calculated even if the number of uneven brightness correction data to be used is low (even if it is less than N). For example, the uneven brightness correction data of each gradation value can be calculated even if the number of uneven brightness correction data to be used is 2, although errors may increase.

Now a method for the transfer processing according to this example will be described.

In this example, p number of data, which is a number of data in one line in the row direction, is transferred at one time, and this is repeated for q×N number of times, whereby all the uneven brightness correction data required for displaying the image is transferred (transfer processing is completed). By predetermining a number of data to be transferred at one time, the transfer processing can be easily divided, and division of the transfer processing can be easily adjusted when the boosting processing (e.g. boosting speed) is changed.

in this example, the uneven brightness correction data is transferred one at a time for each display element. In concrete terms, by transferring p number of data for q number of times, one uneven brightness correction data for each display element of the display panel 12, that is a total p×q number of data, are transferred, and the transfer processing is completed by repeating this step N number of times.

A method for the transfer processing is not limited to this. For example, after transferring N number of uneven brightness correction data corresponding to one display element, N number of uneven brightness correction data corresponding to the next display element may be transferred. In other words, N number of uneven brightness correction data may be transferred for p×q number of times. The number of data to be transferred at one time need not be p. For example, the number of data may be q, which is a number of data in one line in the vertical direction, or N, which is a number of data required for each display element, or a number of data corresponding to the sector unit of a flash memory (storage unit).

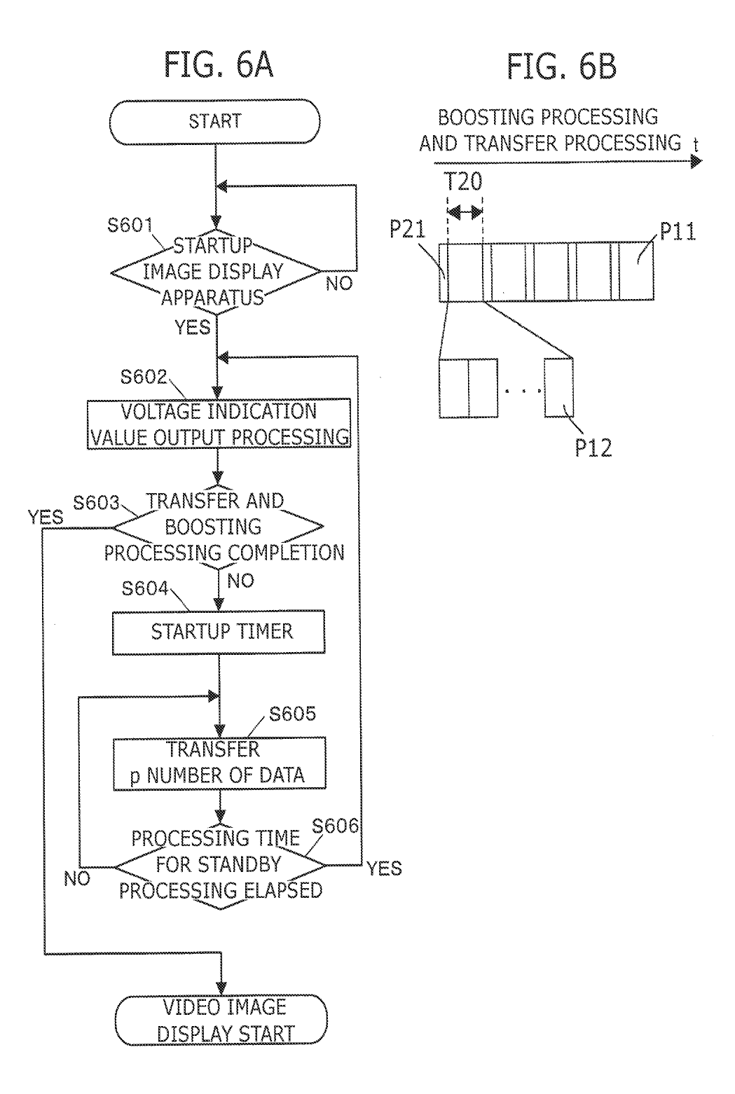

Now an example of processing flow of the image display apparatus until the display of an image is started according to this example will be described with reference to FIG. 6A and FIG. 6B.

When the user instructs to startup the image display apparatus (step S601: YES), the control unit 11 executes the voltage indication value output processing P21 (step S602). Then the control unit 11 determines whether the transfer processing and the boosting processing completed (step S603). If the transfer processing and the boosting processing are completed (step S603: YES), display of the image is started, and if the transfer processing and the boosting processing are not completed (step S603: NO) processing advances to S604. In step S604, the control unit 11 starts up the timer of which measuring time is the same as the processing time T20 of the standby processing.

Next (after step S604), the control unit 11 transfers p number of data from the storage unit 15 to the signal processing unit 13 (step S605: processing P12 in FIG. 6B) After transferring p number of data, the control unit 11 confirms by the timer whether the processing time T20 of the standby processing has elapsed (step S606). If the processing time T20 has not elapsed (step S606: NO) processing returns to step S605, and the next p number of data is transferred. If the processing time T20 has elapsed (step S606: YES), processing returns to step S602, and the next voltage indication value output processing P21 is executed.

Then the processings in step S602 to S606 are repeated until the boosting processing and the transfer processing are completed (until YES is determined in step S603).

In the case of the example in FIG. 6B, it is controlled such that the processing time of the sub-transfer processing P11 becomes the processing time of the standby processing P22 or longer (the processing time of the standby processing P22 is always reset), but the control method (configuration) is not limited to this. For example, if the processing time T20 has not elapsed in step S606, the control unit 11 may calculate the remaining time until the processing time T20 elapses, and determine whether the next p number of data is transferred or not based on this calculation result. Or the control unit 11 may calculate a number of times of processings P12 (processing for transferring p number of data) which can be executed during the processing time T20, and repeatedly execute the processing P12 for the calculated number of times.

As described in Example 1, until the transfer processing and boosting processing are completed, a black image may be displayed or an image in the state where the transfer processing and boosting processing are incomplete may be displayed. In the case when the size (data volume) of the correction parameters is large, for example, it is preferable that an image in a state where correction processing is incomplete is displayed, since it takes a long time to transfer all the data.

For example, the image display apparatus may have a configuration where the image (image of which correction processing is incomplete) is displayed when a predetermined n number of data (n is a natural number, and n≦N), out of N number of data required for each display element, are transferred. In concrete terms, the control unit 11 executes the transfer processing and boosting processing by the above mentioned method. When transfer of the predetermined n number of data is completed for each display element (it is preferable that the boosting processing be already completed), the signal processing unit 13 performs correction on the input video signal using these data, and outputs the result to the display panel. After transfer of the correction parameters (all the uneven brightness correction data) is completed, the signal processing unit 13 performs correction on the input video signal using this data, and outputs the result to the display panel.

As described above, according to this example, the total processing time of the transfer processing and boosting processing can be decreased, just like Examples 1 and 2.

The transfer processing may be executed using a direct memory access controller (DMAC). In other words, the transfer processing may be implemented by the DMA transfer. By implementing the transfer processing by the DMA transfer, the speed of the data transfer can be increased, and the processing time of the transfer processing can be further decreased. The control unit can process another processing, which is not influenced by the bus, in parallel during transfer processing.

If errors occur when executing the transfer processing or boosting processing, force-quit processing may be executed, and control to output the voltage indication value for not supplying the voltage to the display panel may be performed. Thereby an unexpected operation in the image display apparatus can be suppressed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-021938, filed on Feb. 3, 2010, which is hereby incorporated by reference herein in its entirety.

What is claimed is:

1. An image display apparatus, comprising:
a display panel;
a signal processing unit which corrects an input video signal using correction parameters, and outputs the corrected video signal to the display panel;
a power supply unit which supplies voltage to the display panel;
a storage unit which stores the correction parameters; and
a control unit, which, at startup of the image display apparatus, executes boosting processing for boosting voltage supplied from the power supply unit to the display panel up to a voltage required for driving the display panel in stages, and transfer processing for transferring the correction parameters from the storage unit to the signal processing unit, wherein
the transfer processing is processing for intermittently transferring the correction parameters using a period when boosting is not performed in the boosting processing.

2. The image display apparatus according to claim 1, wherein
each of the correction parameters is composed of a plurality of data, and a length of the period when the boosting is not performed is set to a time required for transferring data which is supposed to be transferred using this period or longer.

3. The image display apparatus according to claim 1, wherein
after one of the boosting processing and the transfer processing completes first, the control unit continuously executes the other processing, and then completes this other processing.

4. The image display apparatus according to claim 1, wherein the transfer processing is performed using a direct memory access controller.

5. The image display apparatus according to claim 1, wherein
the display panel is a display panel having a rear plate which has a plurality of electron emitting devices, and a face plate which has a plurality of phosphors disposed facing the plurality of electron emitting devices, and
the power supply unit supplies voltage to the display panel so that a potential of the face plate side is higher than that of the rear plate side.

6. A method for controlling an image display apparatus having a display panel, a signal processing unit which corrects an input video signal using correction parameters, and outputs the corrected video signal to the display panel, a power supply unit which supplies voltage to the display panel, and a storage unit which stores the correction parameters, the method comprising:
a boosting step of boosting voltage supplied from the power supply unit to the display panel up to a voltage required for driving the display panel in stages, at the startup of the image display apparatus; and
a transfer step of transferring the correction parameters from the storage unit to the signal processing unit, wherein
the transfer step is a step of intermittently transferring the correction parameters using a period when boosting is not performed in the boosting step.
